(19) United States
(12) Patent Application Publication
(10) Pub. No.: US 2025/0383030 A1
(43) Pub. Date: Dec. 18, 2025

(54) APPARATUS OF CONTROLLING SOLENOID VALVE, AND ELECTRIC BRAKE SYSTEM AND VEHICLE INCLUDING THE SAME

(71) Applicant: HL MANDO CORPORATION, Pyeongtaek-si (KR)

(72) Inventor: KYUNGRAN CHO, Pyeongtaek-si (KR)

(21) Appl. No.: 18/937,685

(22) Filed: Nov. 5, 2024

(30) Foreign Application Priority Data
Jun. 12, 2024 (KR) 10-2024-0076163

(51) Int. Cl. F16K 31/06; B60T 15/02

(52) U.S. Cl. CPC F16K 31/0675; B60T 15/025

(57) ABSTRACT

The present disclosure relates to an apparatus for controlling a solenoid valve, and an electronic brake system and a vehicle having the same. The apparatus according to an exemplary embodiment of the present disclosure is an apparatus for controlling a solenoid valve in a vehicle, the apparatus including a switch configured to perform a switching operation on a current of a power supply supplied to a solenoid coil of a solenoid valve according to a driving signal; and a freewheeling circuit connected in parallel to the solenoid coil.

### CROSS-REFERENCE TO RELATED APPLICATIONS

This application claims priority to and the benefit of Korean Patent Application No. 10-2024-0076163, filed on Jun. 12, 2024, the disclosure of which is incorporated herein by reference in its entirety.

### BACKGROUND

### Technical Field

The present disclosure relates to a control technology of a solenoid valve, and more particularly, to a control technology having a circuit capable of increasing the off speed of a solenoid valve.

### Description of Related Art

In recent years, electronic brake systems in which the driver's brake pedal operation amount is transmitted as an electrical signal to drive the motor and generate braking pressure according to the driving of the motor have been widely used.

This electronic brake system is equipped with a solenoid valve that performs the function of supplying or blocking brake fluid hydraulic pressure to the wheel cylinder. In this case, the solenoid valve is turned on and off by a current supplied to an internal solenoid coil (hereinafter referred to as a “coil”).

For example, when a switch such as a FET connected to the coil is turned on and a current is supplied to the coil, it may result in a first state in which the solenoid valve is turned on as a magnetic field is applied to the coil. The speed completely switched to this first state may be referred to as an “on speed” or a “magnetic field application speed”.

While, when the switch is turned off to block the current supplied to the coil, the magnetic field application by the coil is released, resulting in a second state in which the solenoid valve is turned off. The speed completely switched to this second state is referred to as an “off speed” or a “magnetic field release speed”.

Meanwhile, vehicles require faster control of the brake, and accordingly, various related arts can be used to increase the response speed (i.e., on and off speed) of the solenoid valve.

For example, the first related art uses a technology that increases the duty of the current controller of PWM (Pulse Width Modulation) for a switch for switching the current supply to the solenoid coil. However, this first related art can only increase the magnetic field application speed of the solenoid valve, but cannot increase the magnetic field release speed of the solenoid valve.

In addition, in the case of the second related art using a current controller of the LSD (low side driving) type, a method of turning off the switch of the LSD at once is used to increase the magnetic field release speed of the solenoid valve. However, in this second related art, the current falling speed is slowed down by the inductance of the coil when the magnetic field of the solenoid valve is released (i.e., when switching to the second state), and accordingly, the magnetic field release speed of the solenoid valve is also bound to be slow.

However, the above-described description merely provides background information about the present disclosure and does not correspond to the previously disclosed technology.

### BRIEF SUMMARY

The present disclosure is directed to providing a new type of control technology capable of increasing the off speed of a solenoid valve (i.e., the magnetic field release speed of a solenoid valve) in a vehicle brake system or the like.

The technical problems to be achieved in the present disclosure are not limited to the technical problems mentioned above, and other technical problems not mentioned will be clearly understood by those of ordinary skill in the art from the following description.

In order to solve the above problems, the control apparatus according to an exemplary embodiment of the present disclosure is a control apparatus for controlling the opening and closing of a solenoid valve in a vehicle, the control apparatus including a switch configured to perform a switching operation on the current of a power supply supplied to a solenoid coil of a solenoid valve according to an applied driving signal; and a freewheeling circuit connected in parallel to the solenoid coil.

The current of the power supply to the freewheeling circuit may be blocked when the switch is turned on, the freewheeling circuit may include a plurality of freewheeling diodes connected in series, and when the switch is turned off, induced current of the solenoid coil may flow through a loop of the solenoid coil and the freewheeling circuit, and the induced current may be consumed by the plurality of freewheeling diodes included in the freewheeling circuit.

The freewheeling circuit may be implemented so that the plurality of freewheeling diodes replace freewheeling resistors.

While the current of the power supply flows through the solenoid coil when the switch is turned on, a magnetic field may be applied to the solenoid coil.

As the magnetic field is applied when the switch is turned on, the solenoid valve may be turned on.

While the induced current is consumed when the switch is turned off, the magnetic field applied to the solenoid coil may be reduced.

As the magnetic field is reduced when the switch is turned off, the solenoid valve may be turned off.

The rate at which the magnetic field is reduced by the plurality of freewheeling diodes may increase when the switch is turned off.

The plurality of freewheeling diodes may include a first and a second freewheeling diodes, the first freewheeling diode comprise a first and a second electrodes, and the second freewheeling diode comprises a third and fourth electrodes, a first end of the solenoid coil may be connected to one end of the switch, and the current from the power supply may flow to a second end of the solenoid coil, and the first electrode of the first freewheeling diode may be connected to the fourth electrode of the second freewheeling diode, the third electrode of the second freewheeling diode may be connected to the first end of the solenoid coil, and the second electrode of the first freewheeling diode may be connected to the second end of the solenoid coil.

The first and the third electrode may include anodes, and the second and the fourth electrode may include cathodes.

The electronic brake system according to an exemplary embodiment of the present disclosure includes a solenoid valve configured to regulate braking hydraulic pressure; a controller configured to generate a control signal for controlling the opening and closing of the solenoid valve; a driver configured to generate a driving signal in accordance with the control signal; a switch configured to perform a switching operation on the current of a power supply supplied to a solenoid coil of a solenoid valve according to the driving signal; and a freewheeling circuit connected in parallel to the solenoid coil.

The current of the power supply to the freewheeling circuit may be blocked when the switch is turned on, the freewheeling circuit may include a plurality of freewheeling diodes connected in series, and when the switch is turned off, induced current of the solenoid coil may flow through a loop of the solenoid coil and the freewheeling circuit, and the induced current may be consumed by the plurality of freewheeling diodes included in the freewheeling circuit.

The present disclosure configured as described above can increase the off speed of a solenoid valve (i.e., the magnetic field release speed of a solenoid valve) in a vehicle brake system or the like.

In addition, the present disclosure can reduce failure occurrence (e.g., FIT rate, etc.) compared to employing one diode by employing a plurality of diodes in the freewheeling circuit for the coil of a solenoid valve.

In addition, the present disclosure only needs to be partially changed in the circuit of the existing control apparatus of a solenoid valve, so it can be manufactured at a low cost.

The effects of the present disclosure are not limited to those mentioned above, and other effects not mentioned will be clearly understood by those of ordinary skill in the art from the following description.

### BRIEF DESCRIPTION OF THE SEVERAL VIEWS OF THE DRAWINGS

FIG. 1 shows a schematic block diagram of a control apparatus 10 according to exemplary embodiments of the present disclosure.

FIG. 2 shows an example of a hydraulic circuit diagram of an electronic brake system to which a control apparatus 10 according to exemplary embodiments of the present disclosure may be applied.

FIG. 3 shows a schematic circuit configuration diagram of a control apparatus 10A according to a first embodiment of the present disclosure.

FIG. 4 shows the flow of current Iₒₙ₁ in the first state in which the switch Q is turned on in FIG. 3.

FIG. 5 shows the flow of current I_{off1} in the second state in which the switch Q is turned off in FIG. 3.

FIG. 6 shows a schematic circuit configuration diagram of a control apparatus 10B according to a second embodiment of the present disclosure.

FIG. 7 shows the flow of current Iₒₙ₂ in the first state in which the switch Q is turned on in FIG. 6.

FIG. 8 shows the flow of current I_{off2} in the second state in which the switch Q is turned off in FIG. 6.

### DETAILED DESCRIPTION

The above-mentioned objects, means, and effects thereof of the present disclosure will become more apparent from the following detailed description in relation to the accompanying drawings, and accordingly, those skilled in the art to which the present disclosure belongs will be able to easily practice the technical idea of the present disclosure. In addition, in describing the present disclosure, when it is determined that a detailed description of a related known technology may unnecessarily obscure the subject matter of the present disclosure, the detailed description will be omitted.

Hereinafter, a preferred embodiment according to the present disclosure will be described in detail with reference to the accompanying drawings.

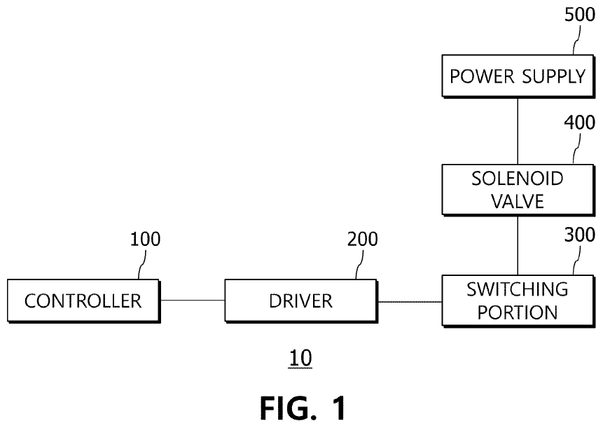

FIG. 1 shows a schematic block diagram of a control apparatus 10 according to exemplary embodiments of the present disclosure.

The control apparatus 10 according to exemplary embodiments of the present disclosure is an apparatus applied to a vehicle, and is an apparatus that controls a solenoid valve 400. Referring to FIG. 1, the control apparatus 10 may include at least one of a controller 100, a driver 200, a switching portion 300, a solenoid valve 400, and a power supply 500. In addition, the control apparatus 10 may further include a freewheeling circuit 600 to be described later.

The control apparatus 10 may control whether the solenoid valve 400 is turned on or off (i.e., opened or closed). For example, the control apparatus 10 may be a control apparatus included in an electronic brake system.

In this case, the electronic brake system is an electronic control brake system that generates a braking force required to decelerate or stop the vehicle. That is, the electronic brake system is a system that brakes by converting a driver's brake pedal pressing force into an electrical signal in place of a system in which the driver directly adjusts the hydraulic pressure of the brake to brake the vehicle. That is, when the driver presses the pedal, the simulator attached to the pedal turns it into an electrical signal and transmits it to an electronic control unit (ECU), and the ECU can control the hydraulic motor by calculating the vehicle condition and braking force. In this case, the control apparatus 10 may be included in the ECU.

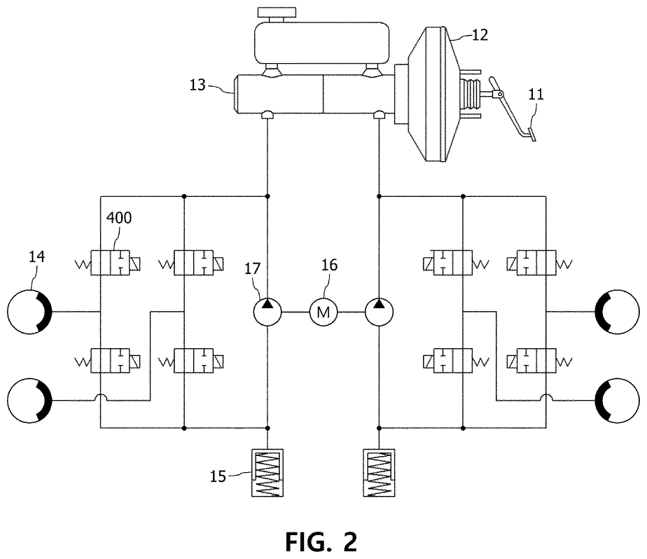

FIG. 2 shows an example of a hydraulic circuit diagram of an electronic brake system to which a control apparatus 10 according to exemplary embodiments of the present disclosure may be applied.

For example, referring to FIG. 2, the electronic brake system may include a brake pedal 11 operated by a driver during braking, a booster 12 and a master cylinder 13 for generating brake pressure by amplifying a force transmitted from the pedal 11. In addition, there may be provided multiple solenoid valves 400 for supplying the generated brake fluid hydraulic pressure to a wheel cylinder 14, a low pressure accumulator 15 for temporarily storing the brake fluid discharged from the wheel cylinder 14, and a motor 16 and pump 17 for pumping the brake fluid stored in the low pressure accumulator 15 and freewheeling it to the master cylinder 11 or the wheel cylinder 14.

The solenoid valve 400 may be disposed on the inlet side and the outlet side of the wheel cylinder 14, respectively, to introduce or discharge brake fluid hydraulic pressure generated in the master cylinder 13 and supplied to the wheel cylinder 14. In this case, at least one solenoid valve 400 may be a normal open valve that normally maintains an open state, and at least another solenoid valve 400 may be a normal closed valve that usually maintains a closed state. Depending on the braking, the brake pressure in the wheel cylinder 14 may be decompressed, maintained, or increased as the solenoid valve 400 is opened in an on state or closed in an off state.

For example, when increasing pressure, the normal closed solenoid valve 400 may be closed and the normal open solenoid valve 400 may be opened to supply brake fluid pumped by motor 16 and pump 17 to the wheel cylinder 14. In addition, when decompressing, the normal open solenoid valve 400 may be closed and the normal closed solenoid valve 400 may be opened to drain the brake fluid of the wheel cylinder to the low pressure accumulator 15 to reduce the brake pressure in the wheel cylinder 14.

In the control apparatus 100, a controller 100 performs various control functions in the control apparatus 10. Accordingly, the controller 100 may include a processor and a memory. For example, the controller 100 may include at least one micro control unit (MCU).

The processor may process various control functions of the controller 100 using information stored in the memory. For example, the memory may include a volatile memory such as a DRAM or an SRAM, or a non-volatile memory such as a PRAM, an MRAM, a ReRAM or a NAND flash memory, or the like, or a hard disk drive (HDD) or a solid state drive (SSD), or the like, but is not limited thereto. In addition, the memory may be a cache, a buffer, a main memory, or an auxiliary memory or the like depending on its purpose/location, but is not limited thereto.

In the control apparatus 100, the driver 200 outputs a driving signal for driving the switching portion 300 according to a control signal of the controller 100. In this case, the driver 200 may control the switching portion 300 so that the current value flowing through the solenoid coil SC (hereinafter referred to as “coil SC”) of the solenoid valve 400 reaches the target current value.

In the control apparatus 100, the switching portion 300 may perform a switching operation on the current supplied from the power supply 500 to the coil SC. In this case, the switching portion 300 may include a switch Q that performs an on/off switching operation according to a driving signal of the driver 200, and a diode DO connected between one end and the other end of the switch Q to prevent a current in the reverse direction from flowing through the switch Q. Of course, one end of the switch Q may be connected to one end of the coil SC, and the other end of the switch Q may be connected to the ground GND.

The switch Q may be implemented as a field effect transistor (FET) including a gate electrode, a drain electrode, and a source electrode. For example, the FET may include a metal oxide semiconductor FET (MOSFET) or a junction gate FET (JFET), but is not limited thereto.

When the switch Q is implemented as an FET, the gate electrode of the switch Q may be connected to the driver 200 to apply a driving signal of the driver 200. In addition, the first electrode of the diode DO may be connected to one of the drain electrode and the source electrode of the switch Q, and the second electrode of the diode DO may be connected to the other one of the drain electrode and the source electrode of the switch Q. In this case, in the diode DO, the first electrode may be an anode and the second electrode may be a cathode. That is, one end of the switch Q may be any one of a drain electrode and a source electrode, and the other end of the switch Q may be the other one of a drain electrode and a source electrode.

In the control apparatus 100, the solenoid valve 400 performs an opening/closing operation of on/off while current is applied or cut off to the coil SC according to the switching operation of the switch Q. That is, the solenoid valve 400 may perform an opening/closing operation according to whether a current is supplied to the internal coil SC. In addition, the solenoid valve 400 may supply or block brake fluid hydraulic pressure to the wheel cylinder 14 according to the corresponding opening/closing operation. In this case, in the solenoid valve 400, the magnetic field may be applied by the coil SC or the magnetic field applied by the coil SC may be released according to the switching operation in which the switch Q is turned on/off.

For example, when the switch Q is turned on, a current is supplied to the coil SC and a magnetic field is applied by the coil SC, and accordingly, it may be in the first state in which the solenoid valve 400 is turned on. The speed completely switched to this first state may be referred to as an “on speed” or a “magnetic field application speed”. Meanwhile, when the switch Q is turned off, the current supplied to the coil SC is cut off, and thus the magnetic field applied by the coil SC is released, and accordingly it may be in the second state in which the solenoid valve 400 is turned off. The speed completely switched to this second state is referred to as an “off speed” or a “magnetic field release speed”.

The power supply 500 supplies power required for each component of the control apparatus 10. In particular, the power supply 500 includes a battery and may supply power V_{bat} from the battery to the solenoid valve 400. Accordingly, in the solenoid valve 400, one end of the coil SC may be connected to one end of the switch Q, and the other end of the coil SC may be connected to the battery of the power supply 500.

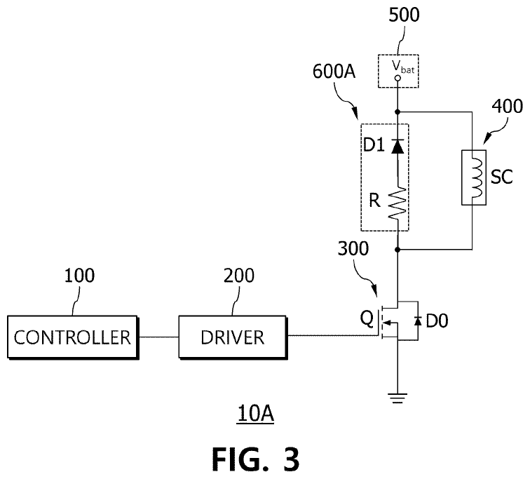

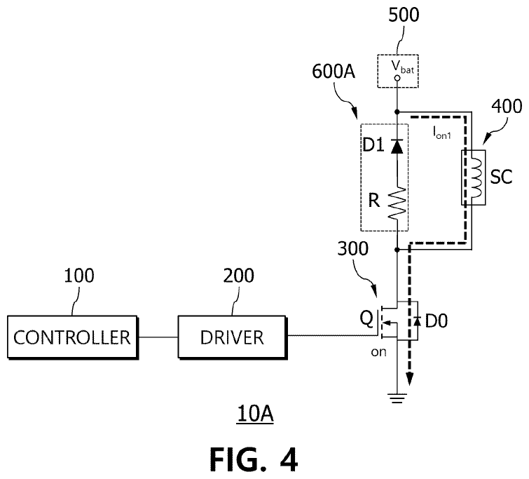

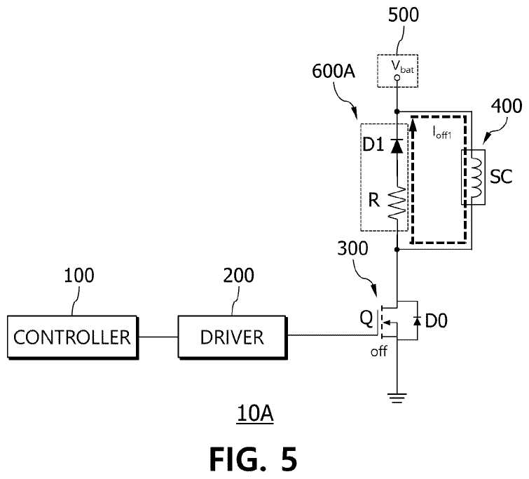

FIG. 3 shows a schematic circuit configuration diagram of a control apparatus 10A according to a first embodiment of the present disclosure, FIG. 4 shows the flow of current Iₒₙ₁ in the first state in which the switch Q is turned on in FIG. 3, and FIG. 5 shows the flow of current I_{off1} in the second state in which the switch Q is turned off in FIG. 3.

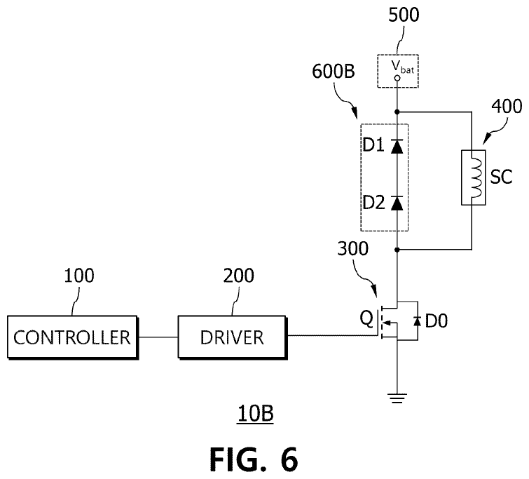

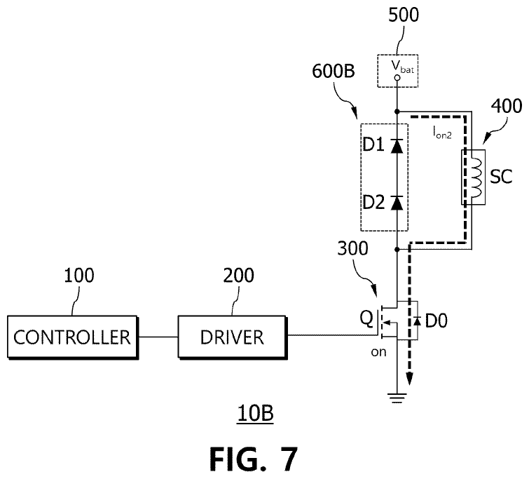

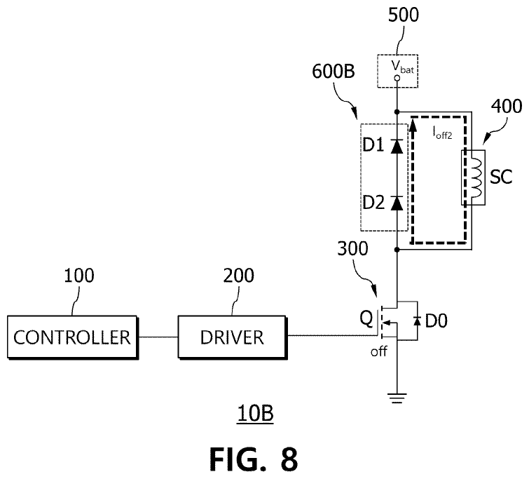

In addition, FIG. 6 shows a schematic circuit configuration diagram of a control apparatus 10B according to a second embodiment of the present disclosure, FIG. 7 shows the flow of current Iₒₙ₂ in the first state in which the switch Q is turned on in FIG. 6, and FIG. 8 shows the flow of current I_{off2} in the second state in which the switch Q is turned off in FIG. 6.

Meanwhile, vehicles need faster control of the brakes. Accordingly, the control apparatus 10 proposes the first and second embodiments to increase the response speed (i.e., the on speed and the off speed) of the solenoid valve 400. In this case, the first and second embodiments may increase the response speed of the solenoid valve 400 while solving the problems of the first and second related arts described above.

That is, in order to increase the response speed of the solenoid valve 400, in particular, to increase the off speed, the first and second embodiments may further include freewheeling circuits 600A and 600B commonly connected to one end and the other end of the coil SC and connected in parallel with respect to the coil SC.

In particular, the second embodiment corresponds to an improved technique than the first embodiment. However, the configuration and operation of the first and second embodiments will be described first, and then these improvements will be described later.

First, in the first embodiment, referring to FIG. 3, the freewheeling circuit 600A may include a first freewheeling diode D1 and a freewheeling resistor R, respectively. In this case, the first freewheeling diode D1 and the freewheeling resistor R may be connected in series. That is, the first electrode (the lower part in FIG. 3) of the first freewheeling diode D1 may be connected to one end (the upper part in FIG. 3) of the freewheeling resistor R, the other end (the lower part in FIG. 3) of the freewheeling resistor R may be connected to one end (the lower part in FIG. 3) of the coil SC, and the second electrode (the upper part in FIG. 3) of the freewheeling diode D1 may be connected to the other end (the upper part in FIG. 3) of the coil SC. In this case, in the first freewheeling diode D1, the first electrode may be an anode and the second electrode may be a cathode.

Referring to FIG. 4, when the driver 200 applies a first driving signal to the switch Q according to a first control signal of the controller 100, the switch Q may be turned on. As the switch Q is turned on, a voltage in the reverse direction (i.e., a reverse voltage) is applied to the first freewheeling diode D1 provided in the freewheeling circuit 600A in relation to the freewheeling circuit 600A and the coil SC connected in parallel. Accordingly, the current Iₒₙ₁ according to the power V_{bat} of the battery of the power supply 500 hardly flows in the freewheeling circuit 600A and mostly flows in the coil SC. Accordingly, when a magnetic field is generated in the coil SC by Iₒₙ₁ flowing through the coil SC, the solenoid valve 400 may be in the first state of being turned on. In this case, Iₒₙ₁ may flow from the other end of the coil SC through the coil SC to the other end of the coil SC.

Thereafter, referring to FIG. 5, when the driver 200 applies a second driving signal to the switch Q according to a second control signal of the controller 100, the switch Q may be turned off. As the switch Q is turned off, current according to the power V_{bat} of the battery is blocked in relation to the freewheeling circuit 600A and the coil SC connected in parallel. However, during this blocking process, the magnetic field application in the coil SC is released, and as a result, as the magnetic field in the coil SC is reduced, an induced current I_{off1} is generated according to the inductance of the coil SC. In this case, I_{off1} may flow from the other end of the coil SC through the coil SC to the other end of the coil SC in the same manner as Iₒₙ₁.

In this case, a forward voltage (i.e., a constant voltage) is applied to the first freewheeling diode D1 provided in the freewheeling circuit 600A, and I_{off1} flows in a loop formed by the coil SC and the freewheeling circuit 600A. In this case, the power according to I_{off1} is consumed by the freewheeling resistor R in the corresponding loop and gradually disappears. Accordingly, the solenoid valve 400 may be in the second state of being turned off.

Unlike the first and second related arts, in the case of the first embodiment, I_{off1} generated according to the inductance of the coil SC when releasing the magnetic field of the solenoid valve 400 (i.e., when switching to the second state) is consumed by the first freewheeling diode D1 and the freewheeling resistor R, so that the current falling speed of the corresponding I_{off1} may be increased. Accordingly, the first embodiment may increase the magnetic field release speed of the solenoid valve 400.

Next, in the second embodiment, referring to FIG. 6, the freewheeling circuit 600B may include a first freewheeling diode D1 and a second freewheeling diode D2 respectively. In this case, the first freewheeling diode D1 and the second freewheeling diode D2 may be connected in series. That is, the second freewheeling diode D2 corresponds to a component that replaces the freewheeling resistor R of the first embodiment. Accordingly, the first electrode (the lower part in FIG. 6) of the first freewheeling diode D1 may be connected to the fourth electrode (the upper part in FIG. 6) of the second freewheeling diode D2, the third electrode (the lower part in FIG. 6) of the second freewheeling diode D2 may be connected to one end (the lower part in FIG. 6) of the coil SC, and the second electrode (the upper part in FIG. 6) of the first freewheeling diode D1 may be connected to the other end (the upper part in FIG. 6) of the coil SC. In this case, in the first and second freewheeling diodes D1 and D2, the first and the third electrode may be anodes, and the second and the fourth electrode may be cathodes.

Referring to FIG. 7, when the driver 200 applies a first driving signal to the switch Q according to a first control signal of the controller 100, the switch Q may be turned on. As the switch Q is turned on, a reverse voltage is applied to the first and second freewheeling diodes D1 and D2 provided in the freewheeling circuit 600B in relation to the freewheeling circuit 600B and the coil SC connected in parallel. Accordingly, the current Iₒₙ₂ according to the power V_{bat} of the battery of the power supply 500 hardly flows in the freewheeling circuit 600B and mostly flows in the coil SC. Accordingly, when a magnetic field is generated in the coil SC by Iₒₙ₂ flowing through the coil SC, the solenoid valve 400 may be in the first state of being turned on. In this case, Iₒₙ₂ may flow from the other end of the coil SC through the coil SC to the other end of the coil SC.

Thereafter, referring to FIG. 8, when the driver 200 applies a second driving signal to the switch Q according to a second control signal of the controller 100, the switch Q may be turned off. As the switch Q is turned off, current according to the power V_{bat} of the battery is blocked in relation to the freewheeling circuit 600B and the coil SC connected in parallel. However, during this blocking process, the magnetic field application in the coil SC is released, and as a result, as the magnetic field in the coil SC is reduced, an induced current I_{off2} is generated according to the inductance of the coil SC. In this case, I_{off2} may flow from the other end of the coil SC through the coil SC to the other end of the coil SC in the same manner as Iₒₙ₂.

In this case, a constant voltage is applied to the first and second freewheeling diodes D1 and D2 provided in the freewheeling circuit 600A, and I_{off2} flows in a loop formed by the coil SC and the freewheeling circuit 600B. In this case, the power according to I_{off2} is consumed by the freewheeling resistor R in the corresponding loop and gradually disappears. Accordingly, the solenoid valve 400 may be in the second state of being turned off.

Unlike the first and second related arts, in the case of the second embodiment, I_{off2} generated according to the inductance of the coil SC when releasing the magnetic field of the solenoid valve 400 (i.e., when switching to the second state) is consumed by the first and second freewheeling diodes D1 and D2, so that the current falling speed of the corresponding I_{off2} may be increased. Accordingly, the second embodiment may increase the magnetic field release speed of the solenoid valve 400.

Taken together, the first and second embodiments correspond to a technology capable of increasing the magnetic field release speed of the solenoid valve 400 by including, by a freewheeling circuit, a configuration capable of increasing power consumption for I_{off1} and I_{off2} flowing in the loop during a magnetic field release process (i.e., an off process) of the solenoid valve 400.

In particular, the freewheeling circuit 600B according to the second embodiment has an advantage of reducing the failure occurrence rate (FIT rate) compared to the freewheeling circuit 600A according to the first embodiment.

For example, the probability of failure for one freewheeling diode may be 80% in the case of a short failure and 20% in the case of an open failure. In this case, assuming that the failure probability for one freewheeling diode is A FIT, the failure probability of the first freewheeling diode D1 may be approximately (80%×λ)+(20%×λ)=λ in the first embodiment.

Meanwhile, in the case of the second embodiment, even if the first freewheeling diode D1 fails, the second freewheeling diode D2 may be operated, so that a normal freewheeling circuit operation may be performed. However, when such a failure occurs, the magnetic field release speed of the solenoid valve 400 is only relatively increased. That is, in the case of the second embodiment, the failure probability according to the first and second freewheeling diodes D1 and D2 is approximately 20%×λ=0.2λ, which may reduce the failure occurrence rate by approximately 80% compared to the first embodiment. That is, the second embodiment may increase the magnetic field release speed as in the first embodiment, and at the same time, may further reduce the failure occurrence rate than the first embodiment.

Although exemplary embodiments of the present disclosure have been described, the idea of the present disclosure is not limited to the embodiments set forth herein. Those of ordinary skill in the art who understand the idea of the present disclosure may easily propose other embodiments through supplement, change, removal, addition, etc. of elements within the same idea. However, the embodiments will be also within the idea scope of the present disclosure.

1. A apparatus for controlling a solenoid valve in a vehicle, the apparatus comprising:
a switch configured to perform a switching operation on a current of a power supply supplied to a solenoid coil of the solenoid valve according to a driving signal; and
a freewheeling circuit connected in parallel to the solenoid coil,
wherein the current of the power supply to the freewheeling circuit is blocked when the switch is turned on,
wherein the freewheeling circuit comprises a plurality of freewheeling diodes connected in series, and
wherein an induced current of the solenoid coil flows through a loop of the solenoid coil and the freewheeling circuit, and the induced current is consumed by the plurality of freewheeling diodes in the freewheeling circuit when the switch is turned off.

2. The apparatus of claim 1, wherein the plurality of freewheeling diodes replaces freewheeling resistors in the freewheeling circuit.

3. The apparatus of claim 1, wherein a magnetic field is applied to the solenoid coil while the current of the power supply flows through the solenoid coil when the switch is turned on.

4. The apparatus of claim 3, wherein the solenoid valve is turned on as the magnetic field is applied, when the switch is turned on.

5. The apparatus of claim 1, wherein the magnetic field applied to the solenoid coil is reduced while the induced current is consumed when the switch is turned off.

6. The apparatus of claim 5, wherein the solenoid valve is turned off as the magnetic field is reduced when the switch is turned off.

7. The apparatus of claim 3, wherein the rate at which the magnetic field is reduced by the plurality of freewheeling diodes increases when the switch is turned off.

8. The apparatus of claim 1, wherein the plurality of freewheeling diodes includes a first and a second freewheeling diodes, the first freewheeling diode comprise a first and a second electrodes, and the second freewheeling diode comprises a third and fourth electrodes,
wherein a first end of the solenoid coil is configured to be connected to an end of the switch, and the current from the power supply flows to a second end of the solenoid coil, and
wherein the first electrode of the first freewheeling diode is configured to be connected to the fourth electrode of the second freewheeling diode, the third electrode of the second freewheeling diode is configured to be connected to the first end of the solenoid coil, and the second electrode of the first freewheeling diode is configured to be connected to the second end of the solenoid coil.

9. The apparatus of claim 8, wherein the first and the third electrodes include anodes and the second and the fourth electrodes include cathodes.

10. An electronic brake system of a vehicle, the system comprising:
a solenoid valve configured to regulate braking hydraulic pressure;
a controller configured to generate a control signal for controlling the solenoid valve;
a driver configured to generate a driving signal in accordance with the control signal;
a switch configured to perform a switching operation on a current of a power supply supplied to a solenoid coil of the solenoid valve according to the driving signal; and
a freewheeling circuit connected in parallel to the solenoid coil,
wherein the current of the power supply to the freewheeling circuit is blocked when the switch is turned on,
wherein the freewheeling circuit comprises a plurality of freewheeling diodes connected in series, and
wherein an induced current of the solenoid coil flows through a loop of the solenoid coil and the freewheeling circuit, and the induced current is consumed by the plurality of freewheeling diodes in the freewheeling circuit when the switch is turned off.

11. The system of claim 10, wherein the plurality of freewheeling diodes replaces freewheeling resistors in the freewheeling circuit.

12. The system of claim 10, wherein a magnetic field is applied to the solenoid coil while the current of the power supply flows through the solenoid coil when the switch is turned on.

13. The system of claim 12, wherein the solenoid valve is turned on as the magnetic field is applied when the switch is turned on.

14. The system of claim 10, wherein the magnetic field applied to the solenoid coil is reduced while the induced current is consumed when the switch is turned off.

15. The system of claim 14, wherein the solenoid valve is turned off as the magnetic field is reduced when the switch is turned off.

16. The system of claim 12, wherein the rate at which the magnetic field is reduced by the plurality of freewheeling diodes increases when the switch is turned off.

17. The system of claim 10,
wherein the plurality of freewheeling diodes includes a first and a second freewheeling diodes, the first freewheeling diode comprise a first and a second electrodes, and the second freewheeling diode comprises a third and fourth electrodes,
wherein a first end of the solenoid coil is configured to be connected to an end of the switch, and the current from the power supply flows to a second end of the solenoid coil, and
wherein the first electrode of the first freewheeling diode is configured to be connected to the fourth electrode of the second freewheeling diode, the third electrode of the second freewheeling diode is configured to be connected to the first end of the solenoid coil, and the second electrode of the first freewheeling diode is configured to be connected to the second end of the solenoid coil.

18. A vehicle comprising:
a controller for controlling a solenoid valve,
wherein the controller comprises:
a switch configured to perform a switching operation on a current of a power supply supplied to a solenoid coil of the solenoid valve according to a driving signal; and
a freewheeling circuit connected in parallel to the solenoid coil,
wherein the current of the power supply to the freewheeling circuit is blocked when the switch is turned on,
wherein the freewheeling circuit comprises a plurality of freewheeling diodes connected in series, and
wherein an induced current of the solenoid coil flows through a loop of the solenoid coil and the freewheeling circuit, and the induced current is consumed by the plurality of freewheeling diodes in the freewheeling circuit when the switch is turned off.

19. The vehicle of claim 18, wherein the plurality of freewheeling diodes replaces freewheeling resistors in the freewheeling circuit.

20. The vehicle of claim 18, wherein a magnetic field is applied to the solenoid coil while the current of the power supply flows through the solenoid coil when the switch is turned on.
